(19) United States
(12) Patent Application Publication
(10) Pub. No.: US 2011/0292408 A1
(43) Pub. Date: Dec. 1, 2011

(54) PRINTER AND METHOD THEREOF

(75) Inventors: TENG-YU TSAI, Tu-Cheng (TW); JING-LIN WU, Tu-Cheng (TW); CHUN-WEN WANG, Tu-Cheng (TW); TING-CHIEH LIN, Tu-Cheng (TW); FENG-CHI HSIAO, Tu-Cheng (TW)

(73) Assignee: HON HAI PRECISION INDUSTRY CO., LTD., Tu-Cheng (TW)

(21) Appl. No.: 12/911,971

(22) Filed: Oct. 26, 2010

(30) Foreign Application Priority Data
Jun. 1, 2010 (CN) 201010189526.0

(51) Int. Cl. G06F 15/00

(52) U.S. Cl. 358/1.2; 358/1.9

(57) ABSTRACT

A standalone printer includes a configuration module, a screen, a process module, and a print module. The configuration module can arrange two digital images in a print layout. The screen is configured to display a preview of the print layout with the two digital images. The process module is configured to decode the print layout of the two digital images into a raster image along a decoding orientation. The print module is configured to print the raster image along the decoding orientation. The process module is configured to stream partial raster image to the print module when decoding the print layout. The printer module is configured to print received partial raster image.

### BACKGROUND

1. Technical Field

The present disclosure relates to a standalone printer and a method for printing in the standalone printer.

2. Description of Related Art

Typically, for printing, an image is first decoded in a computer and the decoded image is output to the printer. Subsequently, standalone printers were developed which enabled the digital images to be input directly to the printer via flash memory cards. However, when printing an image, decoding in a standalone printer requires sufficient memory to decode the complete image, and then store the decoded image and print the decoded image. When two or more images are printed at one time, considerable memory is required. Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a standalone printer in accordance with an embodiment.

FIG. 2 shows the direction of a print layout decoding in the standalone printer of FIG. 1.

FIG. 3 is a flowchart of a method for printing in a standalone printer in one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

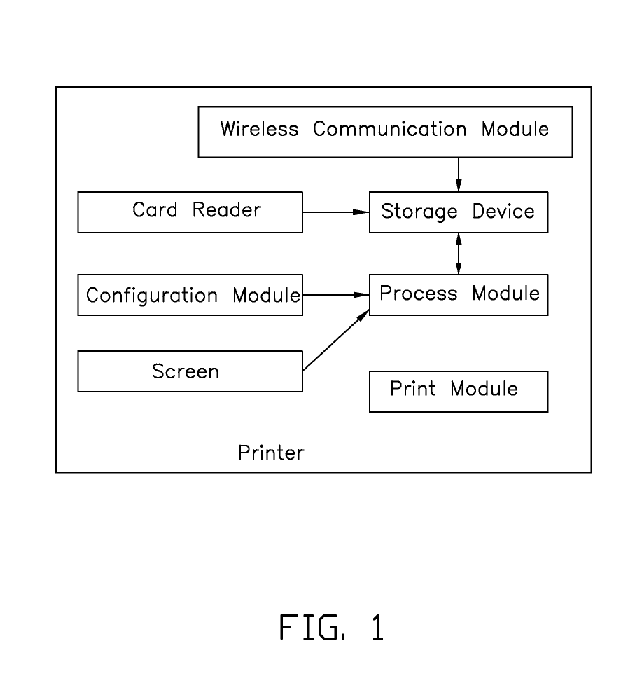

Referring to FIG. 1, a standalone printer in one embodiment includes a card reader, a wireless communication module, a storage device, a process module, a user interface module, a touch screen, and a print module.

The card reader is connected to the storage device. The card reader can directly read a storage card, such as Secure Digital (SD) card, Multi-Media (MMC) card, Compact Flash (CF), or other.

The wireless communication module is connected to the storage device. The storage device can receive digital images through the wireless communication module.

The storage device may store a plurality of digital images.

In one embodiment, the screen may be a touch screen.

The configuration module may arrange at least two digital images from the storage device into a print layout. In one embodiment, two digital images are arranged in the print layout. The print layout is a print arrangement on one media sheet. Print layout can conform to ISO 216 international standard paper sizes, such as A4, A5, or other; or be defined by users. The configuration module may arrange the two digital images in the print layout according to defined margins and a distance between the two images. Placement of each of the two digital images can also be arranged by the configuration module.

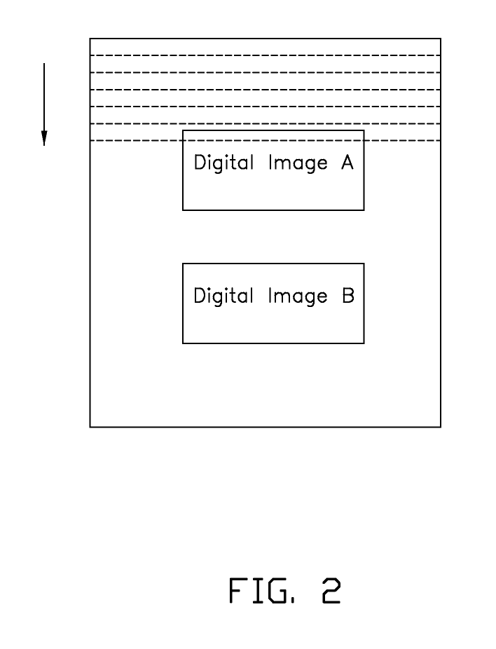

Referring to FIG. 2, the process module may gradually decode the print layout with the two digital images into a raster image along a decoding orientation. In on embodiment, the decoding orientation may extend from a top edge of the print layout to a bottom edge of the print layout. The print layout is decoded from the top edge of the print layout to the bottom edge of the print layout. When partial raster image is generated, the process module can stream the partial raster image to the print module simultaneity.

The printer module can print the partial raster image streamed from the process module simultaneity along the decoding orientation. The storage device may record the print layout after the raster image is printed completely.

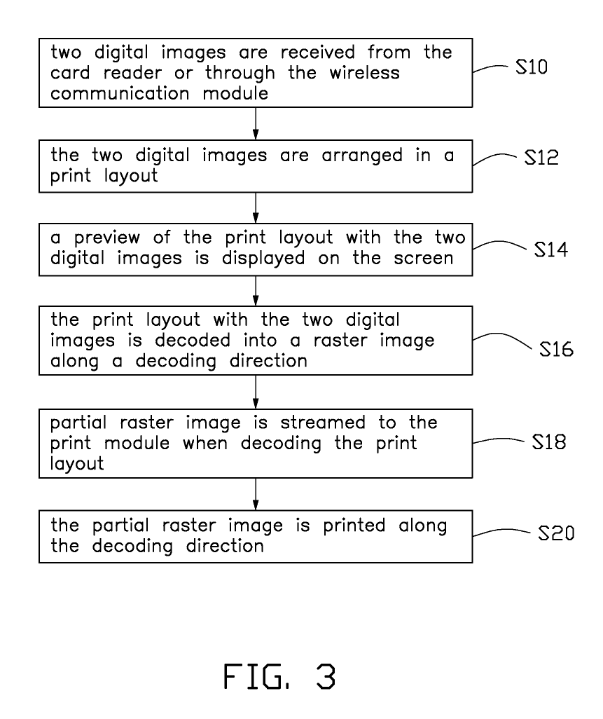

Referring to FIG. 3, steps S10 to S20 appear on a flowchart of a method for printing in a standalone printer in one embodiment.

In step S10, two digital images are received from the card reader or through the wireless communication module. The two digital images are then stored in the storage device.

In step S12, the two digital images are arranged in a print layout.

In step S14, a preview of the print layout with the two digital images is displayed on the screen.

In step S16, the print layout with the two digital images is decoded into a raster image along a decoding orientation.

In step S18, partial raster image is streamed to the print module when decoding the print layout.

In step S20, the partial raster image is printed along the decoding orientation.

The storage device can further record the print layout after the raster image is printed completely.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A standalone printer, comprising:
a configuration module configured to arranging two digital images in a print layout;
a screen configured to display a preview of the print layout of the two digital images;
a process module configured to decode the print layout with the two digital images into a raster image along a decoding orientation; and
a print module configured to print the raster image along the decoding orientation;
wherein the process module is configured to stream a partial raster image to the print module when decoding the print layout, and the printer module is configured to print the partial raster image.

2. The standalone printer of claim 1, wherein the configuration module is configured to arrange the two images according to a defined margin and a distance between the two images.

3. The standalone printer of claim 1, wherein the configuration module is configured to arrange a placement of each of the two digital images.

4. The standalone printer of claim 1, wherein the configuration module is configured to select or defining a size of the print layout.

5. The standalone printer of claim 1 further comprising a card reader and a storage module, wherein the card reader is connected to the storage module.

6. The standalone printer of claim 1 further comprising a wireless communication module and a storage module, wherein the wireless communication module is connected to the storage module.

7. The standalone printer of claim 1, wherein a storage device is configured to record the print layout after the raster image is printed.

8. A method for printing for a standalone printer, the method comprising:
arranging two digital images in a print layout;
displaying a preview of the print layout of the two digital images;
decoding the print layout with the two digital images into a raster image along a decoding orientation;
streaming a partial raster image to a print module when decoding the print layout; and
printing the partial raster image along the decoding orientation.

9. The method of claim 8, wherein the arranging two digital images in the print layout further comprises arranging the two digital images according to a defined margin and a distance between the two images.

10. The method of claim 9, wherein the arranging two digital images in the print layout further comprises arranging a placement of each of the two digital images.

11. The method of claim 9 further comprising selecting or defining a size of the print layout.

12. The method of claim 9 further comprising receiving the two digital images from a card reader.

13. The method of claim 9 further comprising receiving the two digital images through a wireless communication module.

14. The method of claim 9 further comprising recording the print layout after the raster image is printed.
